(19) United States
(12) Patent Application Publication
(10) Pub. No.: US 2017/0304908 A1
(43) Pub. Date: Oct. 26, 2017

(54) Apparatus for machining ceramic articles

(71) Applicant: Christian Travert, Davie, FL (US)

(72) Inventor: Christian Travert, Davie, FL (US)

(73) Assignee: Tratech Corp., Ft. Lauderdale, FL (US)

(21) Appl. No.: 15/496,966

(22) Filed: Apr. 25, 2017

Related U.S. Application Data
(60) Provisional application No. 62/327,439, filed on Apr. 25, 2016.

(51) Int. Cl. B23C 1/06; B23Q 11/08; B23Q 3/157

(52) U.S. Cl. CPC B23C 1/06; B23Q 3/15706; B23Q 11/085; B23C 2230/08; B23C 2226/18; B23C 2250/12

(57) ABSTRACT

Apparatus that is particularly suited for machining hard dense ceramic materials comprises a vertical milling machine within an enclosure. The machine has a plurality of slides for moving a spindle holding an end mill in the x, y, and z directions. The x and y slides are located above the elevation of the work table and any workpiece held thereon. Air flows downwardly from the region of the x and y slides and through gaps associated with two fabric shields which have horizontal portions that translate respectively in the x axis and y axis directions. The shields inhibit coolant that contains work piece particulates from traveling upwardly toward the x and y slides. A tool changer system comprises a tool holding tray (30) mounted adjacent the work table within a housing having a movable cover. The housing enables the tool tray to be removed from the enclosure through an access door while the machine tool is operating and coolant is flowing.

This application claims benefit of provisional patent application 62/327,439 filed Apr. 25, 2016, the disclosure of which is hereby incorporated by reference.

### TECHNICAL FIELD

The present invention relates to methods and machinery for mill-cutting materials, particularly hard ceramic materials.

### BACKGROUND

The present invention relates to apparatus which includes milling machines, particularly three-axis vertical milling machines, which are familiar general purpose pieces of equipment used in machine shops and the like to shape workpieces by cutting tool action. Generally, the shank of a tool bit called a milling bit or end mill is held at the end of in a rotating vertical spindle while being moved in three orthogonal directions, familiarly referred to as the x, y and z axes. In most familiar vertical milling machines, the spindle translates up and down along the z axis relative to the work piece which is mounted on a work table that is located vertically beneath the spindle, and the table moves in the horizontal plane along the x and y axes. The table is typically moved by a combination of slides, drive screws, and drivers which are located beneath or adjacent to the table which holds the workpiece. Typically, the path of the tool bit in a modern milling machine is actuated by CNC (computer numerical control). That is, a software program acting in a micro-processor controls the movement of the actuators or drivers which move the spindle and table.

To speed production a CNC vertical milling machine may have a tool changer accessory. Typically, tools bits are held within a standardized adapter that fits the spindle. The tool bit and adapter assemblies are stowed in sockets of a tool storage device which is part of tool changer system. The storage device is spaced apart from the work table. When the time for change from one tool to another arises, because of wear or because a different machining operation is to be carried out, the tool held in the spindle is deposited in an empty socket in the tool storage device. A new tool bit assembly is removed from its place in the storage device and is captured in the lower end of the spindle. Tool bit change is commonly effected by the software with opportunity for operator intervention.

Familiar tool storage devices include a carousel or magazine type device. With such, tool bits or tool bit assemblies are typically are carried on a movable part of the storage device so that, when desired, a tool assembly (or an empty socket, as may apply) is presented at a definite location relative to the spindle. If the machine tool is contained within an enclosure, as is common, then if a subsequent process to be carried out demands a different array of tool bits, machining must be stopped and the enclosure opened to change the tool bit array, thereby slowing production. Thus there is a continuing need for improvements in tool bit changers.

For precision of machining, it is typical for the machine operator to “zero” the tool, that is to input to the machine software the precise location—relative to the work table and work piece held on the table—of the tip of each tool bit that is newly installed in a tool storage device. That not only requires a bit of skill from the operator, but takes time during which the machine is non-productive. Improvements in the process would speed production.

The predominant use of vertical milling machines is for fabricating metal components. A lesser but important use is to machine dense structural ceramic materials, such as Hot Isostatically Pressed (HIP) alumina or monolithic boron carbide. Such ceramic materials present particular problems in machining, including that they are very hard and brittle. One way of milling such workpieces is through the use of diamond coated end mills, with use of a coolant.

Heretofore, persons fabricating hard and strong structural ceramic pieces have often found that tool bit life is short and machining is slow compared to machining even low machinability metals. That means that frequent tool bit changes are needed. Heretofore, the slides of the typical vertical milling machine, which enable movement of the workpiece-holding table in the x and y directions, are prone to premature wear due to infiltration of fine abrasive ceramic particles which are carried from the workpiece location to vicinity of the slides by the coolant, notwithstanding attempts to seal the slides. When slides are worn prematurely they can be costly to rebuild or replace.

Thus, there is a persistent need for improvements in milling machine operations, particularly when such machines are used for machining ceramics.

### SUMMARY

An object of the invention is to provide apparatus particularly suited for machining ceramic materials, and other materials where fine abrasive debris is generated during machining. A further object is to provide apparatus which includes a vertical milling machine system for machining ceramics and other materials that reduces the need to stop a machining operation when there is need to replace the tool set in a tool changer magazine.

In accord with the invention, an embodiment of apparatus comprises an enclosure within which is a vertical milling machine tool. The apparatus comprises a work table for holding a workpiece and a spindle which holds and rotates a tool bit for material removal from the workpiece. A useful tool bit will be a hollow-shank end mill with an electroplated diamond coating surface. The spindle is adapted for vertical z axis motion of the tool bit and is mounted on a combination of slides which move the spindle in both the x axis and y axis horizontal directions.

Within the apparatus, coolant which flows down the spindle and through the hollow tool onto the workpiece then flows downwardly toward a sump at the bottom of the enclosure, to be recirculated to the fluid input portion of the spindle. One or more shields run horizontally within the enclosure and the lower end of the spindle which holds the tool bit, extends through a shield. The shield(s) partitions the interior of the apparatus into an upper region where the slides are located and a lower region where the tool bit and workpiece are located. An air mover flows air downwardly through small openings in, or at the edges of, the shield(s). Preferably there is a plurality of slot like openings at the side walls of the enclosure where the shields run around rollers or reels. The downward flow of air through the slot like openings inhibits coolant spray from the workpiece region from migrating upwardly to the vicinity of the slides.

Preferably, the apparatus comprises two fabric shields which have horizontal portions that extend across part or all of the cross section of the enclosure. The shields are made of sheet material that runs around rollers or reels, to enable the horizontal portions to translate laterally with lateral movement of the spindle. The rollers or reels are closely spaced to the side walls of the enclosure to define the aforementioned small slot like openings for downward air flow.

In further accord with embodiments of the invention, a tool tray having a flat surface that holds a multiplicity of tool assemblies (which comprise tool bits held in adapters) is positioned on a support surface within the lower region of the apparatus, preferably in close proximity to the work table. The tray is contained within a housing that has a movable cover which protects the tray and tools from coolant spray during machining. The cover is openable when needed to enable a change of tool assembly which is held in the spindle. An access door in the side of the enclosure enables the tool tray to be removed from with the lower region of the apparatus while machining is underway, since the housing and associated cover keeps coolant which is spraying about the lower region away from the tool tray and the support surface.

In apparatus of the invention, the slides are not prone to high wear due to infiltration of fine workpiece debris carried by coolant; and productivity is enhanced when a new array of pre-set tool bits can be positioned within the tool changer while machining takes place. The foregoing and other objects, features and advantages of the present invention will become more apparent from the following description of preferred embodiments and accompanying drawings.

### BRIEF DESCRIPTION OF THE DRAWINGS

FIG. 1 is a simplified perspective view of an embodiment of milling machine contained within an enclosure, shown partially cut away.

FIG. 2 is a front view of a portion of the apparatus shown in FIG. 1, showing a tool tray that holds tool bit assemblies in fixed working position adjacent the work table.

FIG. 3 is a perspective view of a tool tray with tool bit assemblies in partial exploded view.

FIG. 4 is a partial end view of the tool tray portion of the machine shown in FIG. 1, showing the housing of the tool tray and its cover.

FIG. 5 is a perspective frontal view of a milling machine enclosure along with a control pendant and an air-liquid separator.

FIG. 6 is a simplified top view of the apparatus in FIG. 5, with the roof removed, showing how the milling machine and tool tray are positioned within the enclosure, and in part, how air flows.

FIG. 7 is simplified side view of the apparatus in FIG. 5, with the enclosure side wall removed and with the sheet which comprises of the x-shield mostly cut away.

FIG. 8 is simplified side view in the same style as FIG. 7, showing less of the shielding and showing in addition air handling apparatus, relocated to the rear of the enclosure from what is shown in FIG. 5.

FIG. 9 is simplified front view of the apparatus in FIG. 5, with the enclosure front panel removed and with the sheet which comprises the y-shield mostly cut away.

FIG. 10 is a perspective view of an x-shield assembly, like that shown in FIG. 9.

FIG. 11 is a perspective view of portions of the x-shield and y-shield combination of FIGS. 6 to 9.

FIG. 12 is a perspective view showing an alternative embodiment x-shield assembly in combination with a y-shield assembly, partially cutaway.

FIG. 13 is a perspective view of a portion of enclosure having a fixed semi-rigid or rigid shield with a central opening within which a spindle may move.

FIG. 13A is a cross section of the apparatus shown in FIG. 13.

FIG. 14 is a perspective view of a portion of enclosure having a “baggy” shield which is fixed to both the spindle and enclosure interior walls.

FIG. 14A is a cross section of the apparatus shown in FIG. 14.

FIG. 15 is a perspective view of a portion of enclosure with a rigid or semi-rigid shield attached to the spindle, showing how the edges of the shield are spaced apart from the interior enclosure walls.

FIG. 15A is a cross section of the apparatus shown in FIG. 15 along with additional shield parts shown in phantom.

### DESCRIPTION

The invention is described in terms of machining ceramic materials, for which it is particularly suited. However, the invention apparatus may be used for machining other materials, such as metals and plastics. The disclosure of U.S. provisional patent application 62/327,439 filed Apr. 25, 2016 is hereby incorporated by reference.

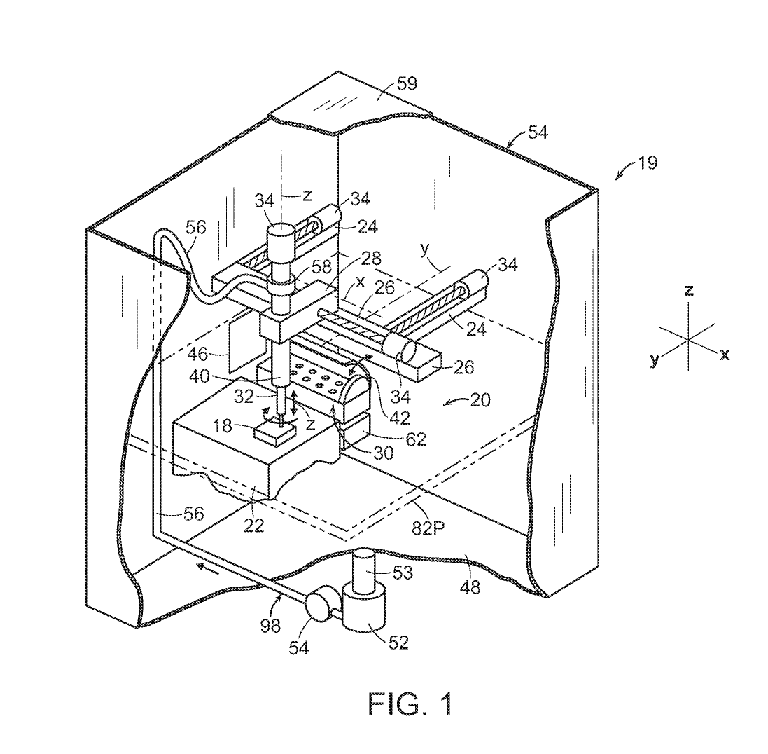

FIG. 1 is a partial cutaway perspective view of an embodiment of apparatus 19 of the present invention, which comprises a machine tool 20 positioned within an enclosure 54. Apparatus 19 includes devices for flowing air and circulating liquid coolant, detailed in other Figures.

FIG. 1 is a simplified rendering: For clarity, only one of some of the components (such as slides and drive motors) is shown. In a preferred embodiment, a pair of slides will be present. Exemplary machine tool 20 is a vertical milling machine which comprises a work table 22 which holding for machining a workpiece 18. Preferably, work table 22 is stationary during machining; optionally the table is adjustable vertically and horizontally, to accommodate different size work pieces.

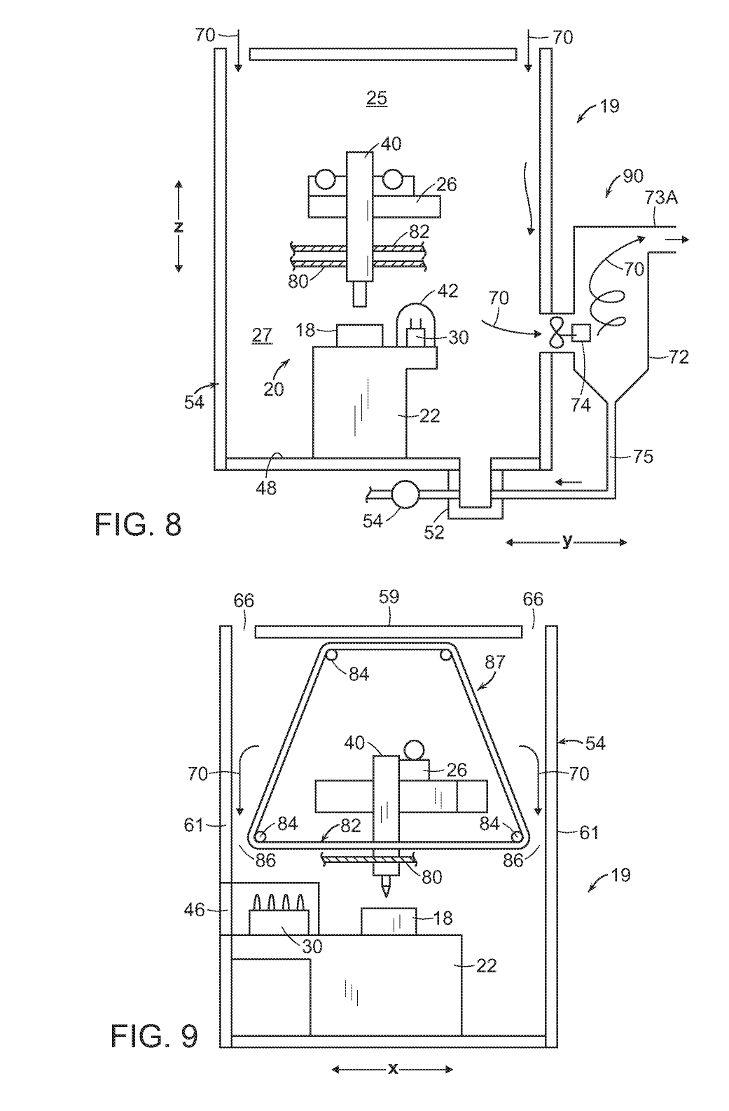

Enclosure 54 that is shaped for containing coolant spray and for guarding against inadvertent operator contact with moving parts of the machine. As described below, embodiments of the invention include one or two shields having horizontal running portions that are engaged with the spindle lower end, just above the tool bit location. For illustrative purpose, phantom shield 82P is shown in semi-schematic form in FIG. 1. A shield partitions the interior of the apparatus into a lower region 27 where workpiece cutting takes place and an upper region 25 where the slides are located and protected. See the vertical cross section of FIG. 8.

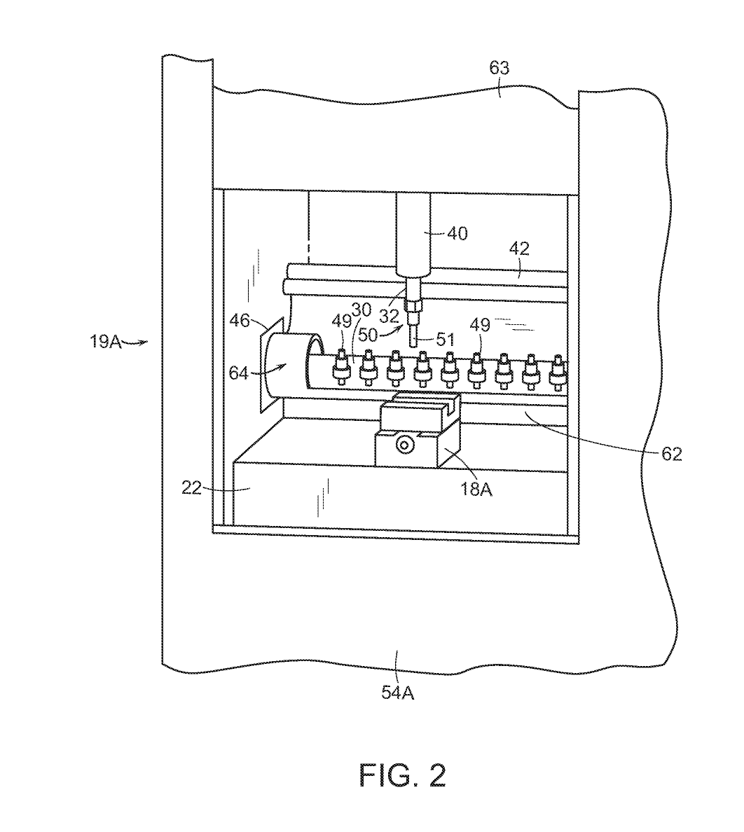

Machine tool 20 is comprised of ball slides (also called linear motion bearings) which are moved by ball screws rotated by drivers. These are familiar commercial articles and are shown in simplified fashion in the Figures; they are referred to herein simply as slides. A vertical spindle assembly (or simply “spindle”) 40 is mounted on a beam 28 which is movable in the x horizontal direction by slide 26. Slide 26 is supported on parallel spaced apart slides 24, for movement (with the spindle) in the y horizontal direction. Generally, spindle 40 may be directly connected to or mounted on a x or y slide, or indirectly connected to a slide, as by means of another structural element. Spindle 40 comprises an internal linear bearing (not visible) which enables vertical z direction movement of the lower end telescoping portion 32 of the spindle. With reference to FIG. 2, a tool bit 51 is held within an adapter to form a tool assembly (also called a tool bit assembly) which is secured to the lower end 32 of the spindle during machining. Actuators 34, such as stepper motors or servo motors, drive the linear motion bearings of the slides and rotate the spindle shaft. Machine tool 20 preferably comprises a computer numeric controlled (CNC) system, not shown, for automatic control of machine motions.

With reference to FIG. 1 and FIG. 2, adjacent to the work table 22 is tool changer tray 30. Tray 30 is removable from its location within the enclosure 54 through access door 46, to enable replacing the tool assemblies within the tray, or for exchanging the tray with another like tray having an array of different tool assemblies. The tool changer, detailed in FIGS. 2 to 4, is discussed further below. A feature of the tool changer system is a housing having a movable cover, so the tool tray may be replaced while machining is being carried out and coolant is spraying about in the lower region of the enclosure.

During machining of a workpiece, a coolant recirculation system 98 provides liquid coolant to the workpiece location. In the typical kind of coolant recirculating system, one of which is embodied in the apparatus of FIG. 1, coolant flows discharged from vicinity of the work piece predominately flows to the floor 48 of the enclosure, to drain line 53, and then to sump 52. By means of pump 54 coolant is flowed from the coolant sump 52 through pressure line 56 (including a flexible hose portion that enables movement of the machine elements) to collar 58 at the upper end of the spindle. Coolant then flows through a lengthwise hollow in the spindle shaft, preferably to enter the hollow end of the shank of a suitable tool bit, then to be discharged through one or more ports on the side-cutting portion and end of the tool bit. Alternately, the coolant is flowed from line 56 to one or more nozzles (not shown) that flood the tool bit 51 and the workpiece cutting zone. Coolant discharged from the workpiece region tends to spray in all directions, but predominately flows downwardly from the work table area to the floor 48 of the enclosure. Suitable filters, fluid coolers, and other known fluid circulating system devices may be employed, so coolant delivered to the cutting region is clean.

When ceramics are being machined the tool bit 51 is preferably a commercial cutting tool having an electroplate surface that contains diamond particulate; and the tool has a hollow shank and one or more cutting surface discharge ports. Fluid flowed down the hollow shaft exits through ports in the side of the tool, to deliver coolant to cutting surface region, thereby providing good cooling and allowing higher rotational cutting tool speeds than can be attained by externally flooding the tool bit. The cutting action of such kinds of tool bits may alternatively be referred to as “cutting,” “machining,” or “grinding.”

A preferred tool bit 51 of the foregoing hollow shank type, suitable for machining ceramics, is a commercial hollow end mill sold by G. G. Shultz Tool Inc., Taveres, Florida. Such type of tool bit, and the associated coolant flow and material removal process, are described in U.S. Patent Publication 2016/0306685 of Rakes et al., dated Oct. 29, 2015; the disclosure of which is hereby incorporated by reference. Another preferred end mill is described in U.S. provisional patent application Ser. No. 62/372,774 of the present inventor, entitled “Diamond coated end mill,” filed Aug. 9, 2016, the disclosure of which is hereby incorporated by reference.

As mentioned, the preponderant flow of spent coolant from the workpiece location is downwardly from the cutting zone. That flow is away from the location of the x-y slides and the actuator for the z-axis direction-moving spindle. The foregoing slide apparatus is most often referred to simply as the “x-y moving parts” hereafter. The x-y moving parts are located higher in elevation than the work table surface and workpiece location. Nonetheless, coolant vapor and a substantial amount of spray which goes in all directions are usually generated, depending on the pressure of the coolant provided to the tool bit, the rotary speed of the tool bit, and the heat generated during machining. And in the absence of features of the invention, substantial amounts of coolant vapor and spray could move to the location of the x-y moving parts, which location is also referred to below as being upper region of the apparatus.

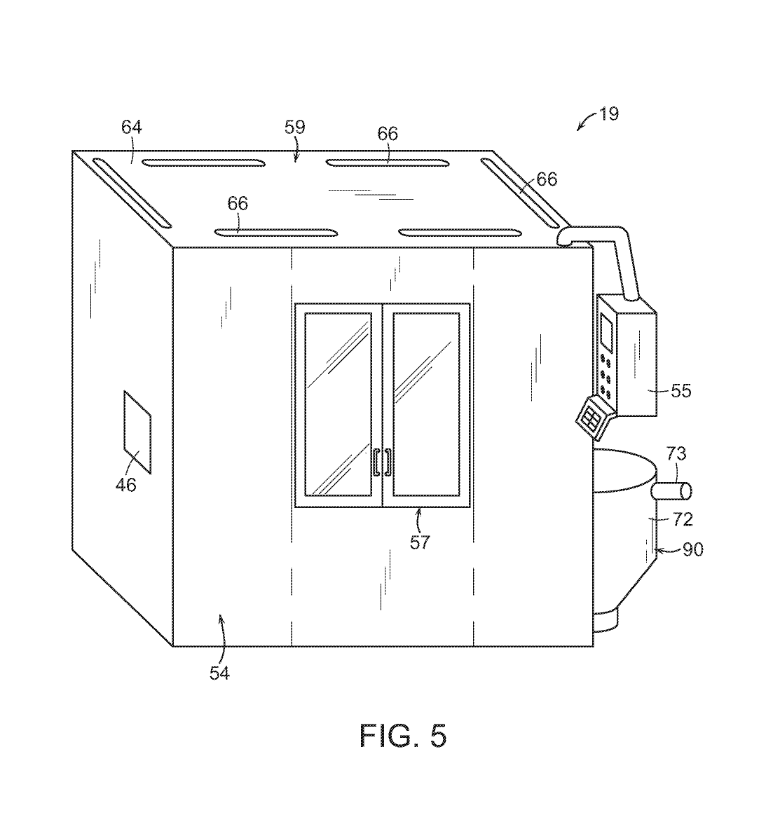

For cleanliness and worker safety, the spray and vapor generated during machining are contained by enclosure 54. Referring especially to FIG. 1 and FIG. 5, embodiments of the apparatus 19 of the present invention include the enclosure 54, the milling machine 18, an air moving subsystem 90 and coolant recirculation subsystem 98. In preferred apparatus 19 air is drawn into and through the portion of enclosure 54 which surrounds the lower region (that which is below the elevation of shield 82P), then out of the lower region to a liquid-air separator 72 connected to the enclosure, to extract most, if not all, of the liquid coolant that is typically carried by the air. Air may be directly flowed from the lower region (and any separator) to the upper region as through ducting, or air may be indirectly flowed, as by being flowed into the natural atmosphere around the apparatus.

Embodiments of the present invention are configured for a particularly advantageous air flow. Generally, the air is channeled in ways which inhibit the extent to which the coolant carrying fine ceramic particulate comes in contact with the x-y moving parts. The preponderance of the flow of airborne coolant is downward, away from the upper region of the apparatus and the location of the x-y moving parts. When the preferred shielding is used, air in the upper region is in flow communication with the air in the lower region. In particular, flows downwardly, past the outer edges of one or more fabric shield portions that substantially run horizontally and through slot like openings associated with rollers or reels (described below), and into the lower region of the apparatus where the workpiece is located and where cutting takes place. Air also may be additionally flowed around the shields by means of a duct.

The present invention contrasts with a common conventional vertical milling machine where the x-y direction slides are located beneath a movable work table. The slides thus are in a region where gravity will cause spent coolant to flow, and slides—notwithstanding shielding—can be prone to infiltration of coolant which carries workpiece and tool debris, resulting in accelerated wear.

FIG. 5 is a frontal perspective view of apparatus 19 of the present invention. In FIG. 5 the vertical milling machine 20 itself and tool tray are not visible at their places within enclosure 54. Enclosure 54 may be made of sheet metal, plastic and the like, to contain the coolant spray and vapor which are generated during use of the machine, and to manage the air flow. Enclosure 54 is rectangular in cross section, but in the generality of the invention an enclosure may have other cross sections including circular. Apparatus 19 which is shown in FIG. 5 also comprises a CNC control pendant 55, front work table access door 57, tool changer door 46, and roof 59.

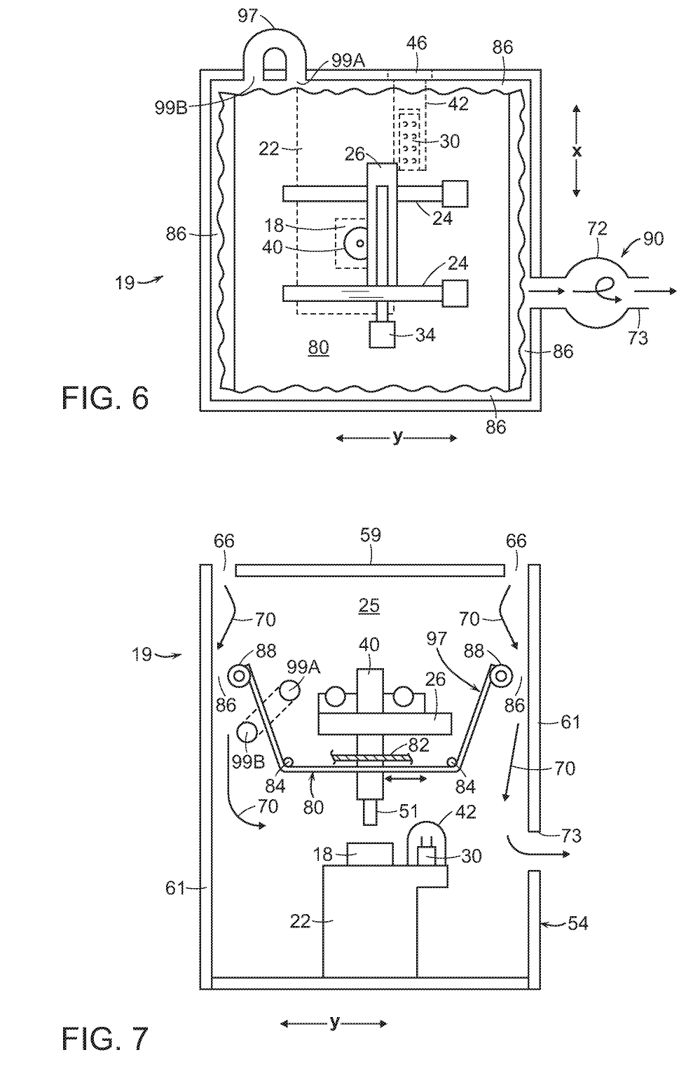

FIGS. 6, 7, 8 and 9 are respectively top, side, side (again), and front views of apparatus 19. In these Figures, which are simplified, differing portions of the enclosure 54 are cut away in each, to reveal milling machine 20, tool changer tray 30 and to illustrate air flow within the apparatus by means of arrows 70. (Compared to FIG. 5, for purposes of illustration simplicity, in FIGS. 6 to 9 the airflow control apparatus is relocated to the rear of the enclosure and enclosure access doors are not shown.)

The air handling system comprises portions of enclosure 54, namely side walls 61 which are below the elevation of the x-y-moving parts. Optionally, the air handling system also comprises the portions of enclosure side walls which extend upwardly to encompass the upper region of the apparatus, as shown in the present Figures. The air handling system also comprises one or more shields which control air flow within the apparatus, one or more air movers 74 (such as a fan or blower), and a liquid-vapor separator such as cyclone separator 72, alternatively a HEPA filter.

Air which is flowed into the lower region 27 within enclosure 54 may be drawn from the shop within which the apparatus 19 is located, moving past the x-y slides and shields. Air which is discharged from the lower region 27 may flow through exit port 73, to a location exterior to the shop within which assembly 19 is located, or with adequate filtering to the shop interior. Alternatively, air mover 74 may be positioned at the exit port 73A of the separator 72. Part or all of the air handling system can be alternatively contained within the enclosure 54. Preferably, the lower region of the apparatus which is inside the enclosure is kept at negative pressure relative to the ambient environment by having the air mover pull air from it, rather than push air into it.

Enclosure 54 preferably has a roof 59 which has a plurality of openings 66 that are spaced apart around the periphery of the roof, as pictured in FIG. 5. In the generality of the invention, the enclosure only need extend upwardly to the elevation of the shield(s) and the enclosure walls above the shield assemblies and the roof at the top of the walls can be considered optional, although perhaps desired for appearance.

Airflow, indicated by arrows 70, is downwardly from the upper region 25 of the apparatus (see FIG. 8), where are positioned the x and y slides to the lower region 27 of the apparatus. Lower region 27 is generally the space that is lower in elevation than the shields and includes the location of the lower end of the spindle and the tool bit. The shields run across the width and depth of the enclosure and cooperatively partition the upper region from the lower region.

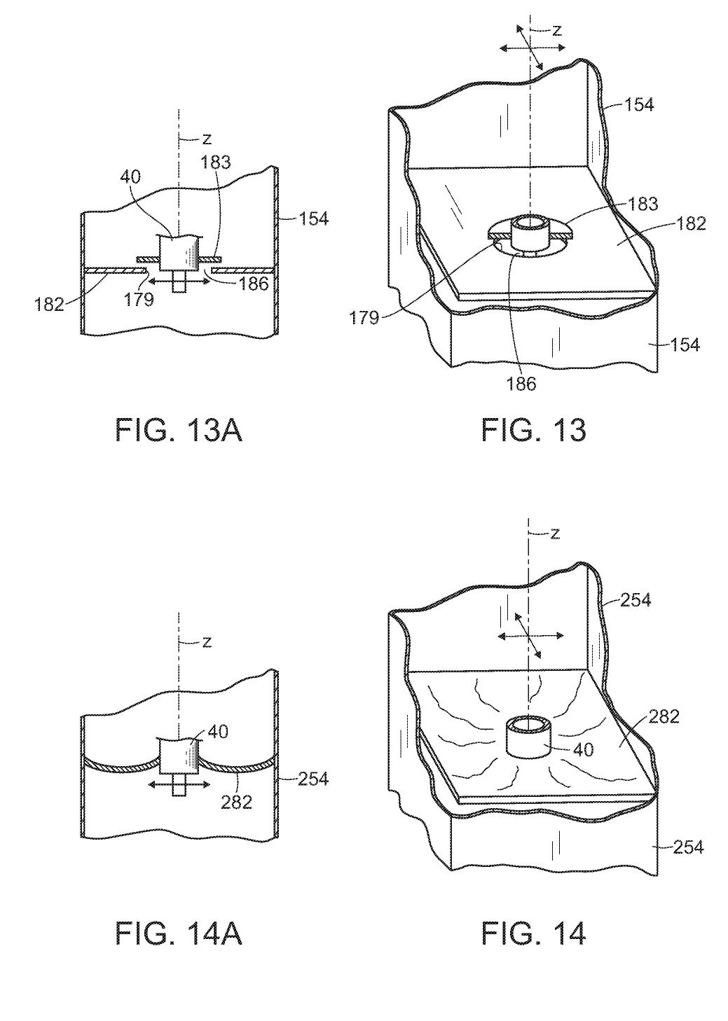

As may be more fully appreciated from the further description below, air flows downwardly around or through the shields (for example, when a shield has an opening as described in connection with FIG. 13), then to the lower region of the apparatus. Preferred shields 80, 82, are portions of shield assemblies 97, 87 respectively. At an elevation just above the lower end 32 of spindle 40 (at an elevation which is also above tool bit 51), the two shields run horizontally, one somewhat above the other as illustrated in FIGS. 7 to 9. Each shield has a through-hole, at which location it is attached by a collar (not shown here) to the outside surface of the spindle 40 or to the spindle telescoping part 32. With reference to FIGS. 7 and 11, the lower horizontal portion of shield 82 runs in the y-axis direction; thus it is referred to as the y-shield. With reference to FIGS. 9 and 11, the lower horizontal portion of shield 80 runs in the x-axis direction; thus it is referred to as the x-shield.

Shields 80, 82 are preferably made of flexible material such as vinyl plastic sheet. The sheet material of the shields largely blocks the movement of coolant spray in the upward direction. Air flow may move downwardly around the lengthwise edges of the shields were they run along the side walls of the enclosures. The airflow obviates the need for seals along the lengthwise edges, although such may optionally be used. Some downward migration of air can take place by flow through the horizontal space between one shield 80 and the other shield 82.

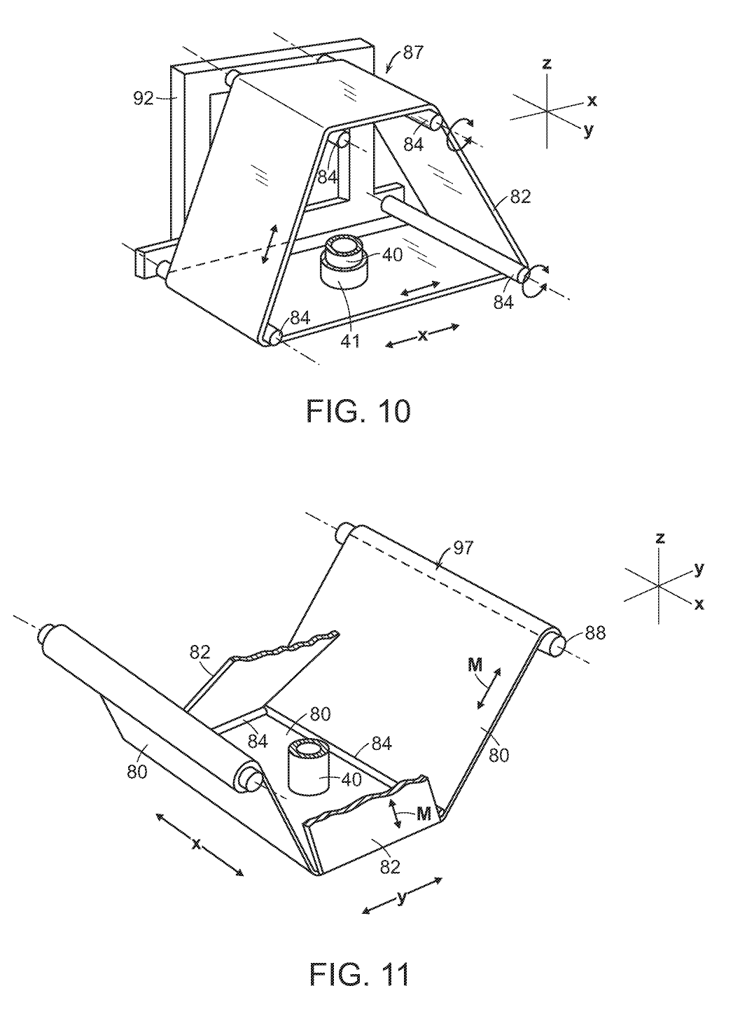

Spindle lateral movement is enabled by translation of the horizontal portion of each shield where it is engaged with the spindle. Vertical spindle part motion may be accommodated by sliding of the spindle through a bellows or slip-fit collar that secures the shield to the spindle exterior. FIG. 10 is semi-schematically illustrative of a collar 41 around spindle 40. For simplicity of illustration the collar is not shown in other Figures.

At the lengthwise extremities of the each shield's horizontal portion, shields 80, 82 run around rollers 84 and then generally upwardly. Movement of the sheets which comprise shields 80, 82 is indicated by double headed arrows M. The x-y motion of the spindle and the spindle engagement with a shield where it penetrates the shield can be sufficient to cause the desired movement M of a shield. Optionally, drives may be applied to the rollers or reels to help movement M.

The x-shield 82 is part of shield assembly 87, which is configured to enable lengthwise x-direction motion of a horizontal portion adjacent the spindle, as is best shown in FIG. 9 and FIG. 10. Shield 82 is in the form of a continuous loop of sheet which runs around rollers 84, and is configured to enable shield 82 to move to and fro along in the x direction, as indicated by arrow M. Rollers 84 are supported at each end by frames 92 (one only shown in FIG. 10) that are fixed relative to the work table 20. With reference particularly to FIG. 9, the lower rollers 84 of shield 82 are positioned close to interior surfaces of the side walls of enclosure 54 to provide a plurality of slot-like spaces 86 along the inner edge of the enclosure so air above the shield can flow downwardly to the elevation of the workpiece. In the Figures, the width dimensions of the slot-spaces 86 are exaggerated for clarity of illustration; preferably the widths are 3 mm or less.

The y-shield 80 is part of shield assembly 97, which is configured to enable lengthwise y-direction motion M, as is best shown in FIG. 7 and FIG. 11. The sheet of shield 80 is a single lengthwise piece which furls and unfurls around opposing side reels 88. Reels 88 are coupled to each other, as by a cable or belt loop (not shown), so that when one reel rotates the other reel is also caused to rotate; thus the shield is desirably kept taut. Alternatively, spring or driver powered biasing of the reels may be used to keep shield 80 from sagging. The positioning of the reels within the enclosure is such as to provide between the fabric furled on a reel and the side wall of the enclosure a slot like opening 86 through which air may flow downwardly during operation of the apparatus. See FIG. 7. In an alternative embodiment to shield 82, the rollers 84 of the shield may be positioned closer to the side walls of the enclosure than illustrated, so the desired slot like openings are at the elevations of rollers 84, rather than at the elevations of reels 88.

What is the desirable area for a slot like opening depends on the size of the machine and the amount of air which is moved through the machine. Generally, to save energy it is undesirable to require a large air mover. In a preferred embodiment of the invention, the area of each slot like opening is small compared to the cross section area of the machine. As an example, for a shield that spans a rectangular cross section enclosure having a width/length that is about 90 or 100 cm, each slot like opening might have a width of about 0.3 cm. Smaller and larger slot shape openings may be employed and the openings may vary from place to place within an apparatus. Preferably, the total area of slot openings for airflow, measured in the horizontal plane, is less than about 5 percent, more preferably about 1 percent of the cross section area of the enclosure. The air mover is sized both to ensure adequate flow downward velocity through all slot like openings, sufficient to prevent upward flow of coolant and particulate bearing air, and as desired, to thin out or to carry away a misty atmosphere of fine droplets in vicinity of the workpiece, so the operator can better see the workpiece, spindle and interior of the enclosure.

During use, it may be desirable to have more airflow in the workpiece area than the slots provide or to direct the air differently from that which the channeling of the slots provides. As shown in FIG. 6 and FIG. 7, for such purpose optional bypass duct 97 flows clean air from port 99A which is above the horizontal shield portions to port 99B which is below the horizontal shield portions. In other embodiments, there may be two or more such bypass ducts.

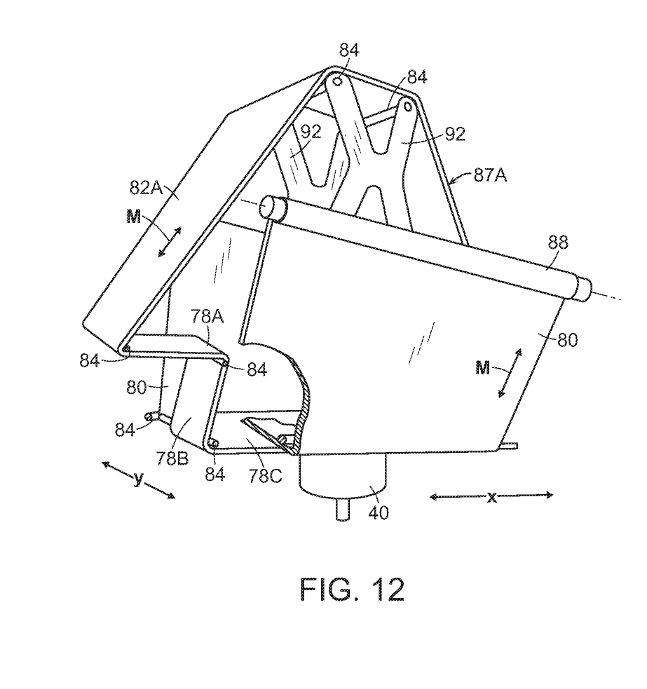

FIG. 12 shows an alternate embodiment combination of shields. Shield 80 is part of an assembly which is much like assembly 97 previously described in connection with FIG. 11. Shield assembly 87A which comprises shield 82A is functionally similar to shield assembly 87 of FIG. 10. Shield 82A runs in a loop around a plurality of rollers 84. X-shape frames 92A support the rollers 84 which at the upper end of the assembly. Additional frame parts which hold other rollers 84 are omitted for clarity of illustration. At the lower elevations of shield 82A, the sheet of the shield runs as follows: a portion 78A of runs laterally and inwardly (with respect to the enclosure 54); a next-portion 78B runs downwardly, and a next portion 78C runs horizontally to analogous shield configurations on the opposite side of the enclosure. The embodiment of FIG. 12, compared to the embodiment of FIG. 10, can provide improved access to things in vicinity of the work table. The slot-like openings along the enclosure side walls are located at an elevation higher than the central horizontal-running portion 78C of the shield.

In an alternative embodiment of the invention, the x-shield may be configured as a reel system and the y-shield may be configured as a continuous loop system. In still other embodiments, both shields may be continuous loop shields or both may be reel-configured shields. If a particular machine tool necessitated only x axis or y axis motion, then only one such shield may be used in carrying out the invention. In the generality of the embodiments of the invention presently being described, at least one shield has a horizontal plane portion through which the lower end of the spindle—or at least the tool bit—projects downwardly, and the horizontal plane portion is configured for moving in opposing shield lengthwise directions.

When shields are characterized as having lower portions which run horizontally, within the scope of invention, that means the shield lower portion is substantially horizontal. By “substantially horizontal” is meant that when running from one to another more or less same elevation locations, a shield may run along a partially or fully sloping, curved, or undulating path.

FIG. 13 to FIG. 15 show other embodiments of shields that may be used for machine tools, particularly those which are dedicated to machining workpieces which do not require a large amount of x-y motion, compared to the dimensions of the enclosure interior—and those workpieces do not need the capability of a universal or versatile conventional milling machine as has been described above. FIGS. 13 to 15 show simplified portions of an enclosure and the spindle of a machine tool, and can be further understood by their relation to FIGS. 6 to 11. In each FIGS. 13 to 15 the z-axis is shown for reference. The horizontal double headed arrows suggest the horizontal (x and or y) motion of which the spindle is capable. For each FIG. 13, 14, 15, a corresponding FIG. 13A, 14A, 15A shows a vertical partial cross section of the apparatus.

FIG. 13 and FIG. 13A show enclosure 154 within which is shield 182. The shield has inherent material stiffness or incorporates stiffening members or is a lightweight rigid member. For example, shield 182 may be formed of semi-rigid plastic sheet that sags only a bit. Shield 182 is self-supporting due to attachment to the side walls of the enclosure, around the periphery of the interior of the enclosure. Shield 182 has a port 179 which defines an annular space 186 around the spindle 40. Thus during use, the spindle can move within the space 186 while air flows downwardly through the space 186, from the upper region above the shield to a lower region below the shield, where the work table is located. Preferably, a disk 183 is attached to the exterior of the spindle 40 and extends radially outwardly over the surface of shield 182 to make smaller the path through which air (or coolant spray) may flow. The lower surface of disk 183 may rest on the upper surface of shield 182.

FIG. 14 and FIG. 14A show enclosure 254 within which is shield 282. Shield 282 is formed of flexible sheet like that described in connection with the previously-described shields 82, 80. Optionally, the sheet of shield 181 has an elastic character. Shield 282 is fastened to the interior sidewalls of the enclosure 254 and to the spindle 40. As illustrated in the vertical cross section of FIG. 14A, shield 282 has dimensions larger than the cross section of the closure, so the shield drapes downwardly and provides slack; that allows the spindle to move horizontally even though it is secured to the walls by the shield. Notwithstanding the slack and sloping of the shield 282, within the meaning of the claims herein, the shield runs substantially horizontally.

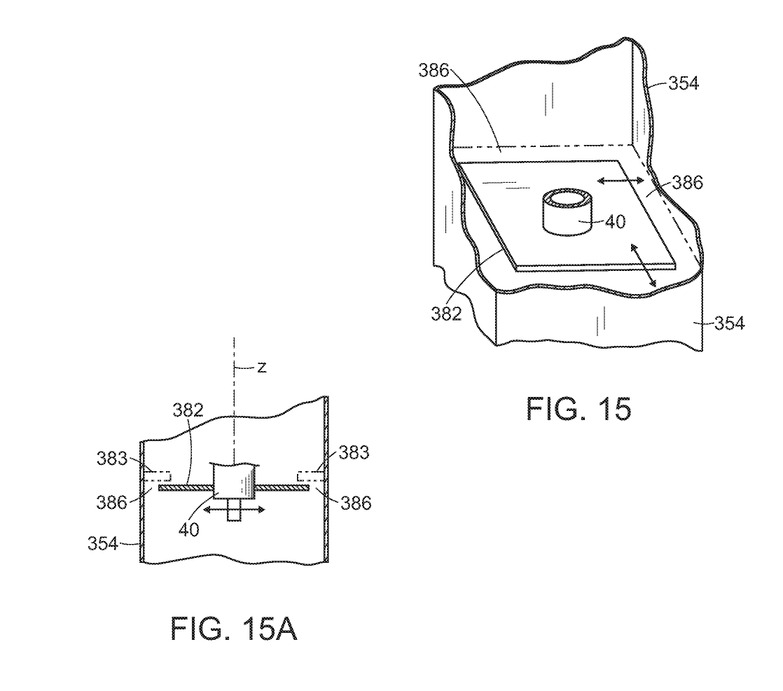

FIG. 15 and FIG. 15A show enclosure 354 within which is shield 382. Shield 382 is formed of semi-rigid material like that described for shield 182. Shield 382 is fixedly attached to spindle 40 and is smaller in dimension that the width and depth of the interior of enclosure 354. Thus, there is a gap 386 between the outer edges of the shield and the interior wall of the enclosure. Thus, the spindle 40 can move laterally to the extent of closing the gap, and perhaps even a bit more, if elastic flexing of the shield is possible and tolerable. Preferably, a flange 383, shown in phantom in FIG. 15A, extends laterally inward around the periphery of the enclosure, to narrow the space in vicinity of gap 386 through which air may flow.

While air preferably enters the enclosure through roof openings (when there is a roof), in alternative embodiments, the air may enter elsewhere, while accomplishing the same result of protecting the x-y moving parts by downward air flow from the vicinity of such parts. For example, air may flow through openings at the upper portions of the side walls of the enclosure, when the enclosure extends upwardly from the location of the x-y slides. In another example, the enclosure in the region above the shield may be pressurized by an air mover which causes air to flow downwardly from vicinity of the x-y moving parts.

It will be appreciated that use of the foregoing apparatus comprises a method of machining, particularly for ceramics, which in short is: machining a workpiece with a tool bit while flowing liquid coolant to the workpiece location where machining takes place, and recirculating the coolant; providing apparatus with x-y slides located above one or more shields with partition the apparatus in to an upper region and a lower region where workpiece cutting takes place; and flowing air downwardly from the upper region to the lower region past one or more shields, so the air inhibits coolant spray in the lower region from moving upwardly into the upper region and contacting the x-y slides.

The following description is about a system comprising a tool tray which holds tool assemblies. The tool tray is contained within a housing within the enclosure of the apparatus. Such tool change system is useful with the apparatus 19 and is described in such relation. The tool change system of the present invention may be used in connection with other machine tools and other enclosures, including those in which there is no airflow or associated shields.

FIG. 2 is a partial front view of assembly 19A which is largely like assembly 19. Spindle 40 and work table 22 are visible through the opening of vertically sliding door 63 in the front wall of enclosure 54A, which is largely like enclosure 54, but for the front door configuration. A vise 18A for holding a workpiece is shown on the work table 22. Tool tray 30 is adjacent the work table, resting on support surface 62.

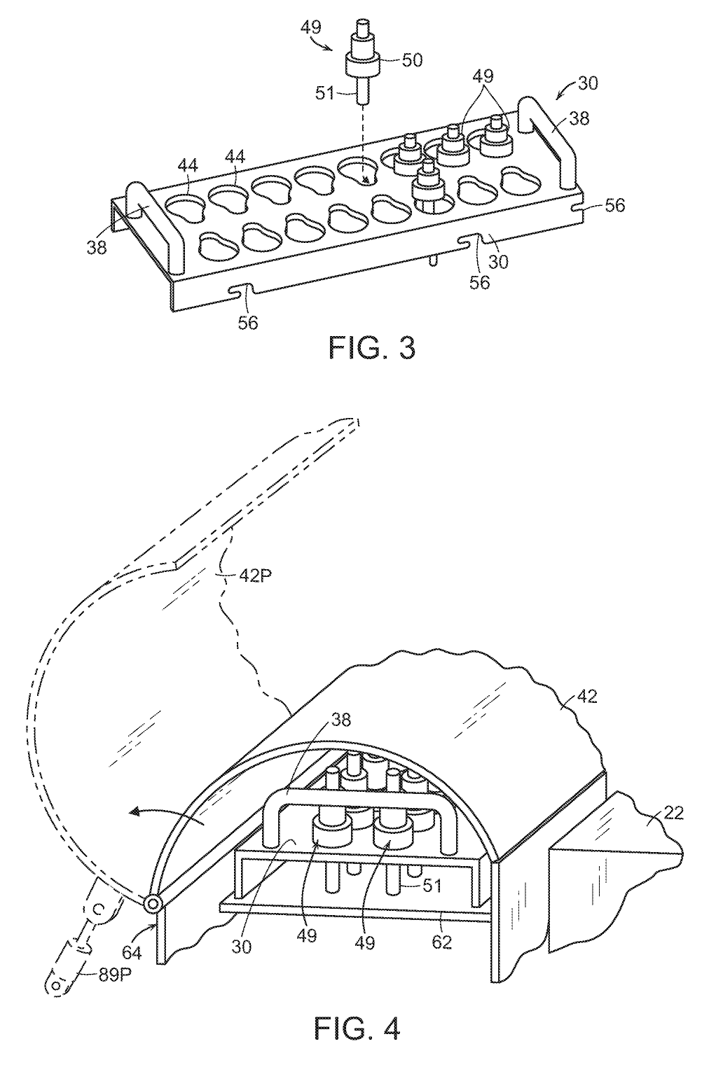

Tool tray 30 is shown in top perspective view in FIG. 3. Referring again to FIG. 1 and FIG. 2, access door 46 on the side wall of enclosure 54 enables the tool tray to be moved to or from its working position adjacent table 22. Stops (not visible) on support 62 engage slots 56 in the tray, for positive location of the tray at its working position relative to the surface of support 62 and thus also relative to the work table 22.

Tray 30 has a multiplicity of keyhole shape slots 44, each shaped for holding a tool assembly 49 which is comprised of tool bit 51 and adapter 50. (Reference may be made again to the beginning of this description.) Tray 30 is preferably elongate; in particular it has a planar rectangular surface. Other shape tool trays, including trays having stepped or other configuration tool-assembly-receiving surfaces, are with the scope of the generality of the invention. A tray for apparatus 19 preferably holds tool assemblies so the shank of the end mill of the assembly lies along the z axis.

Each adapter 50 is shaped for being held in the telescoping end of spindle 32 during machining and for fitting into a slot 44 when stored in the tray. Each adapter 50 has a circumferential groove that engages the smaller portion of the keyhole slot 44, so a tool assembly 49 will not easily fall out of the tray during normal manual handling when the tray is outside the enclosure. For convenience of removing, inserting, and carrying about outside the machine, tray 30 comprises handles 38 at each end.

FIG. 4 shows tool tray 30 as it is viewable through access door 46 in the side of the apparatus, looking in the x axis direction of the machine tool. Tray 30 is resting on the surface of support 62 that is fixed with respect to, and preferably adjacent to, work table 22. While the tray is preferably close to the work table to save machine-moving time, in other embodiments of the invention the tray may be located more remote from the work table.

In the tool change system of the present invention, when in use for machining, tray 30 is contained within housing 64 which has a pivoting cover 42. Housing 64 is fixed relative to the support 62. Cover 42 is shown in the closed position in FIG. 4, where it will protect the tray and tools from spray of debris-containing coolant during machining. The cover is configured so that, in closed position, it enables removal and replacement of the tray from the enclosure while machining is being carried out, with no or little entry of coolant into the place where the tray is located on the support. Thus an operator may replace a tool tray holding a first array of tool assemblies with a like tool tray holding a second array of tool assemblies by means of the access door.

When machining is being carried out, the tool changer system of the present invention enables the spindle (or when used, a robot arm) to deposit a used tool assembly and access an unused tool assembly from the tool tray. To effect a change of assembly held in the spindle, flow of coolant is momentarily ceased and cover 42 is opened. As shown by phantom cover 42P and the curved arrow in FIG. 4, the housing cover swings open under action of an air cylinder 89P or other actuator. (In FIG. 1 the cover is shown partially opened.)

In alternative embodiments of the invention, the cover of the housing may be configured differently than shown, for opening and closing. For instance, the cover may slide lengthwise or the cover may comprise opposing side “clam shells” which hingedly pivot from opposing sides of the housing and which meet at the centerline of the housing. In alternative embodiments, there may be more than one tool tray and associated housing.

As an example of the method of this aspect of the invention, when a tool bit is to be changed the coolant flow is ceased, cover 42 of housing 64 is opened, and the spindle holding a tool assembly moves to the location of an empty slot 44 in the tool tray. The spindle positions and releases the tool assembly so it sets securely within the chosen empty slot. The spindle then moves to the location of the next-desired tool assembly within the tray, and engages it. Engagement with and release of a tool assembly from the spindle may be carried out by a powered drawbar type mechanism internal to the spindle, of a kind which is well known in the art.

When engaging and disengaging from the tool assembly, the spindle telescoping end portion moves predominately vertically (in the z-axis direction). Thus, in the invention the part of the tool assembly which is engaged by the end of the spindle, and the tool bit, are oriented vertically. In the generality of the invention, the tool assemblies could be differently oriented and a robot arm or the like could be added to pull a selected tool assembly out of the tray and present it to, or position it within, the lower end of a spindle.

In use of a tool changer system comprising tray 30 and its housing, prior to the tool tray being placed on the support within the enclosure, each tool assembly can be measured with respect to the distance between the tip or diameter or other feature of the tool bit and a reference point on the adapter—which reference point will be always be located precisely at the same location relative to the end 32 of the spindle 40 when the adapter is being held in a spindle. Such measurements can be done by a skilled technician at a workplace removed from the machine. Data about the measurements can then be electronically communicated at an appropriate time to the control system of machine tool 20 (generally termed a CNC control system), so that when the tool tray is placed within the housing, and when any particular tool assembly is taken up by the spindle from the tray, there will be no need for further calibration or location of the end of the cutting portion of a particular tool bit, prior to commencing machining with that particular tool, in comparison to what is often the case in industry today.

In partial summary: An embodiment of tool changer system of the present invention comprises a housing having openable cover, a tray for holding a multiplicity of cutting tool assemblies oriented for engagement with the spindle by spindle z axis direction motion, a support for holding the tray in vicinity of the work table. The tool tray support and tool tray and housing are configured in a way that enables removing the tray from within the machine enclosure through a door in the side of the enclosure. The foregoing tool changer system may be used with machines other than the vertical milling machine of the type which is shown in FIG. 1. For example, the tool changer system of the present invention may be used with milling machines which have the conventional setup of x-y slides, where the x-y slides are beneath the workpiece holder. For example, the tool changer system may be used with a horizontal milling machine.

When using the preferred tool bits mentioned above, another enhancement facilitated by the present invention relates to the manner (speed and feed) in which the side of an end mill tool bit engages the workpiece, particularly when doing such as making a feature such as a 90 degree inside corner of a pocket. Preferably, the invention apparatus is operated with use of commercial software from SolidCAM, Inc., Newtown, Pa., U.S.A. The invention apparatus is particularly capable of carrying out with accuracy tool path, speeds and feed rates as commanded by the software.

The invention, with explicit and implicit variations and advantages, has been described and illustrated with respect to several embodiments. Those embodiments should be considered illustrative and not restrictive. Any use of words such as “preferred” and variations suggest a feature or combination which is desirable but which is not necessarily mandatory. Thus embodiments lacking any such preferred feature or combination may be within the scope of the claims which follow. Persons skilled in the art may make various changes in form and detail of the invention embodiments which are described, without departing from the spirit and scope of the claimed invention.

What is claimed is:

1. Apparatus having mutually orthogonal x, y, and z axes, wherein the z axis runs vertically, for machining a work piece using a tool bit having a lengthwise axis oriented along the z axis which comprises:
(a) a machine tool comprising
a work table, for holding a work piece;
a spindle, having a lower end portion for directly or indirectly holding and rotating about the z axis the shank of an end mill tool bit, the spindle configured for moving said tool bit in the z axis direction;
one or more slides, connected directly or indirectly to the spindle, for moving the spindle and said tool bit in one or both of the x-axis direction and y-axis direction;
wherein said one or more slides are located at an elevation higher than the elevation of said lower end portion of the spindle; and,
(b) a fluid handling system for channeling and processing liquid coolant and air, comprising
an enclosure, comprised of side walls, a floor, and one or more access doors in a side wall;
one or more shields, each having a horizontal portion that partitions within the apparatus an upper region which is a space at a higher elevation than the spindle lower end portion from a lower region which is a space at a lower elevation than the spindle lower end portion; and,
at least one air mover for flowing air from said upper region to said lower region;
a coolant handling system for flowing coolant from said lower region to vicinity of said spindle lower end portion.

2. The apparatus of claim 1 wherein the horizontal portion of at least one of said shields is movable in the x or y axis direction in coordination with the x or y axis movement of the spindle.

3. The apparatus of claim 1 wherein the horizontal portion of said at least one shield is fastened to either side walls of the enclosure or to the spindle, the shield comprised of semi-rigid sheet.

4. The apparatus of claim 1 wherein the horizontal portion of said at least one shield is fastened to both to the side walls of the enclosure and to the spindle, the shield made of flexible or elastic sheet that enables spindle movement relative to the side walls of the enclosure.

5. The apparatus of claim 2 wherein said at least one shield is made of flexible sheet which runs either as a continuous loop around a multiplicity of spaced apart roller pairs or between reels that are horizontally spaced apart as a reel pair.

6. The apparatus of claim 5 wherein each of the rollers of a roller pair or each of the reels of a reel pair of said at least one shield is located in close proximity to a side wall of the enclosure, so there is a slot-like opening space between each roller or reel and its respective close proximity side wall for flow of air from said upper region to said lower region.

7. The apparatus of claim 5 comprising a first shield having a horizontal portion movable to and fro along one of the x-axis or y-axis; and a second shield made of flexible sheet and having a horizontal portion movable to and fro along a horizontal axis that is at right angles to movement direction of the horizontal portion of the first shield, wherein the horizontal portions of the two shields are in close vertical proximity to each other.

8. The apparatus of claim 7 wherein the first shield comprises a continuous loop of sheet material running around a plurality of rollers, the loop having a lower portion which comprises said horizontal portion of the first shield and the loop having an upper horizontal portion located in said upper region at an elevation which is above the elevation of said slides.

9. The apparatus of claim 8 wherein the second shield comprises sheet having a horizontal portion running between rollers spaced apart along the sheet path and then upwardly from each said roller to a reel about which the sheet furls and unfurls when the spindle moves horizontally.

10. The apparatus of claim 1 further comprising apparatus for separating coolant carried by air, in flow communication with an outflow port of said enclosure located at said lower region, wherein air flows from the apparatus for separating directly or indirectly to said upper region.

11. The apparatus of claim 1 wherein the shield is spaced apart from the side walls of the enclosure location to define at least two slot like spaces for airflow from said upper region to said lower region; further comprising at least one bypass duct, for carrying further air from the upper region to the lower region .

12. The apparatus of claim 1 wherein said enclosure sidewalls extend upwardly to enclose said upper region of the apparatus; further comprising an enclosure roof connecting the sidewalls and covering said upper region, the roof having a plurality of openings for flow of air into the upper region from outside the apparatus.

13. The apparatus of claim 1 wherein the work table is horizontally fixed during machining.

14. Apparatus having mutually orthogonal x, y, and z axes, wherein the z axis runs vertically, for machining a work piece using a tool bit having a lengthwise axis oriented along the z axis which comprises:
(a) a machine tool comprising
a work table, for holding a work piece;
a spindle, having a lower end portion for directly or indirectly holding and rotating about the z axis the shank of an end mill tool bit, the spindle configured for moving said tool bit in the z axis direction;
one or more slides, connected directly or indirectly to the spindle, for moving the spindle and said tool bit in one or both of the x-axis direction and y-axis direction;
wherein said one or more slides are located at an elevation higher than the elevation of said lower end portion of the spindle; and,
(b) a fluid handling system for channeling and processing liquid coolant and air, comprising
an enclosure, comprised of side walls, a floor, and one or more access doors in a side wall;
at least two shields, each made of flexible sheet and having a horizontal portion, the shields cooperatively partitioning the apparatus into an upper region which is a space at a higher elevation than the spindle lower end portion from a lower region which is a space at a lower elevation than the spindle lower end portion; the at least two shields comprising a first shield having a horizontal portion movable to and fro along one of the x-axis or y-axis; and a second shield having a horizontal portion movable to and fro along a horizontal axis that is at right angles to movement direction of the horizontal portion of the first shield; wherein the horizontal portions of the two shields are in close vertical proximity to each other; wherein each of the two shields run either as a continuous loop around a multiplicity of spaced apart roller pairs or between reels that are horizontally spaced apart as a reel pair; wherein each of the rollers of a roller pair and each of the reels of a reel pair of said shields are located in close proximity to a side wall of the enclosure, so there is a slot-like opening space between each roller or reel and its respective close proximity side wall for flow of air from said upper region to said lower region;
at least one air mover for flowing air from said upper region to said lower region; and, a coolant handling system for flowing coolant from said lower region to vicinity of said spindle lower end portion.

15. The apparatus of claim 14 wherein the first shield comprises a continuous loop of sheet material running around a plurality of rollers, the loop having a lower portion which comprises said horizontal portion of the first shield and the loop having an upper portion located in said upper region and above the elevation of said slides; and wherein the second shield comprises sheet having a horizontal portion running between rollers spaced apart along the sheet path, and then upwardly from each said roller to a reel about which the sheet furls and unfurls when the spindle moves horizontally.

16. The apparatus of claim 1 further comprising:
an access door in a sidewall of the enclosure, openable and closeable to enable a tool tray within the lower region of the enclosure to be positioned on or removed from a support surface within the enclosure;
a horizontal support surface for holding a tool tray, positioned within the lower region of the enclosure in proximity to said access door;
a housing for said tool tray, shaped for covering a tool tray set upon said support surface, the housing having a movable cover which prevents coolant or air within the lower region from substantially contacting the support surface and any tool tray resting thereon when the access door is open.

17. The apparatus of claim 16 wherein the movable cover is hinged to the rest of the housing.

18. The apparatus of claim 17 further comprising: a tool tray movably mounted on said work table, the tray having surface for holding a multiplicity of tool assemblies, each tool assembly comprising an adapter and a milling tool bit.

19. The apparatus of claim 16 wherein the support surface is adjacent the work table.

20. A method of machining workpieces which comprises:
(a) providing an apparatus of claim 16, wherein a tool tray having a multiplicity of assemblies is positioned on the support surface;
(b) opening the movable cover of the housing to expose the multiplicity of tool assemblies, each assembly comprising a tool bit;
(c) engaging at one or more tool assemblies serially with the lower end portion of the spindle;
(d) closing the cover of the housing;
(e) machining the work piece using a tool assembly engaged with the spindle while flowing coolant to the vicinity of the lower portion of the spindle and while flowing air from the upper region to the lower region, wherein the cover of the housing protects the tool tray on the support surface; and,
(f) during the machining step, opening the access door in the side of the enclosure and removing the tool tray from the support surface; optionally positioning a second too tray having a second multiplicity of tool assemblies on the support surface; and closing the access door.
